(19) United States
(12) Patent Application Publication
(10) Pub. No.: US 2007/0097583 A1
(43) Pub. Date: May 3, 2007

(54) Tuned Coil Coaxial Surge Suppressor

(75) Inventor: Frank A. Harwath, Naperville, IL (US)

Correspondence Address: BABCOCK IP, PLLC, P.O.BOX 488, 4934 WILDWOOD DRIVE, BRIDGMAN, MI, 49106, US

(73) Assignee: ANDREW CORPORATION, Orland Park, IL (US)

(21) Appl. No.: 11/163,780

(22) Filed: Oct. 31, 2005

(51) Int. Cl. H02H 9/06

(52) U.S. Cl. 361/118

(57) ABSTRACT

An in-line surge suppressor insert and surge suppressor assembly having a body with a coaxial connection at a first and a second connector end. A surge suppressor insert mount is formed in the body between the first end and the second end adapted to receive a surge suppressor insert with a hollow cap having a top and an open end. A wire wound inductor is seated within the hollow cap. The wire wound inductor is coupled to the top at a first end and has a threaded contact at a second end. A center conductor extending between the first connector end and the second connector end, having a threaded hole proximate the surge suppressor insert mount is adapted to mate with the threaded contact as the surge suppressor insert is mated with the surge suppressor mount, coupling the inner conductor to the outer conductor via the wire wound inductor.

### BACKGROUND

1. Field of the Invention

The invention generally relates to surge protection of coaxial cables and transmission lines. More particularly, the invention relates to an exchangable surge suppressor insert and related compact surge protector housing for use in-line with a coaxial cable or transmission line, configurable for a range of different frequency bands.

2. Description of Related Art

Electrical cables, for example coaxial transmission lines of antenna towers, are equipped with surge suppression equipment to provide an electrical path to ground for diversion of electrical current surges resulting from, for example, static discharge and or lightning strikes.

Prior coaxial suppression equipment typically incorporated a frequency selective shorting element between the inner and outer conductors dimensioned to be approximately one quarter of the frequency band center frequency in length, known as a quarter wavelength stub. Therefore, frequencies within the operating band pass along the inner conductor reflecting in phase from the quarter wavelength stub back to the inner conductor rather than being diverted to the outer conductor and or a grounding connection. Frequencies outside of the operating band, such as low frequency surges from lightning strikes, do not reflect and are coupled to ground, preventing electrical damage to downstream components and or equipment.

Depending upon the desired frequency band, a shorting element dimensioned as a quarter wavelength stub may have a required dimension of several inches, requiring a substantial supporting enclosure. Prior quarter wavelength stub surge suppressors, such as described in U.S. Pat. No. 5,982,602 “Surge Protector Connector” by Tellas et al, issued Nov. 9, 1999 commonly owned with the present application by Andrew Corporation and hereby incorporated by reference in the entirety, reduce the required enclosure size by spiraling the stub within the enclosure. However, the required enclosure is still relatively large.

As the spiral aspect of the shorting element increases, an inductance arises. The high frequency magnetic field effects of an inductor structure having an affect on the impedance of the frequency selective shorting element that allows the overall length of the shorting element to be reduced, compared to a straight or loosely spiraled quarter wavelength stub. U.S. Pat. No. 6,452,773 “Broadband Shorted Stub Surge Protector” by Aleksa et al, issued Sep. 17, 2002 commonly owned with the present application by Andrew Corporation and hereby incorporated by reference in the entirety, applies a tubular shorting element with a portion that is machined helically, forming an inductor portion. Although the combination of a stub portion and an inductor portion widens the operating frequency band of the device, different frequency band specific shorting element configurations may still be required to satisfy specific frequency bands. The precision machining of a range of different shorting element configurations, to allow supply of a surge suppressor for each of a range of different frequency bands, adds a significant manufacturing cost and lead time to the resulting family of surge suppressors.

Competition within the electrical cable and associated accessory industries has focused attention on cost reductions resulting from increased manufacturing efficiencies, reduced installation requirements and simplification/overall number of discrete parts reduction.

Therefore, it is an object of the invention to provide an apparatus that overcomes deficiencies in the prior art.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is an isometric exploded schematic view of a first embodiment of the invention.

FIG. 2 is a cut-away side schematic view of the first embodiment of the invention.

FIG. 3 is a schematic exterior side view of an encapsulated wound wire inductor of the first embodiment.

FIG. 4 is a cut-away side schematic view of a surge suppression insert of the first embodiment.

### DETAILED DESCRIPTION

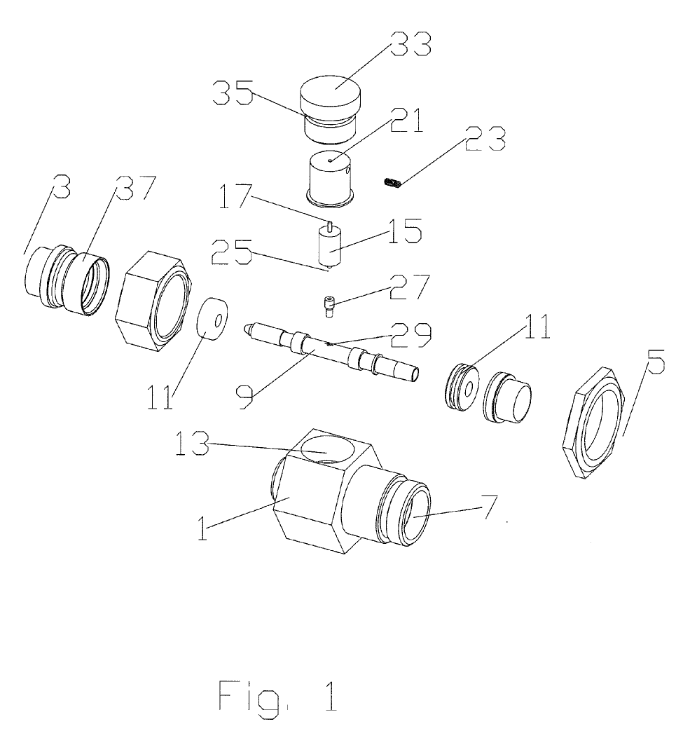

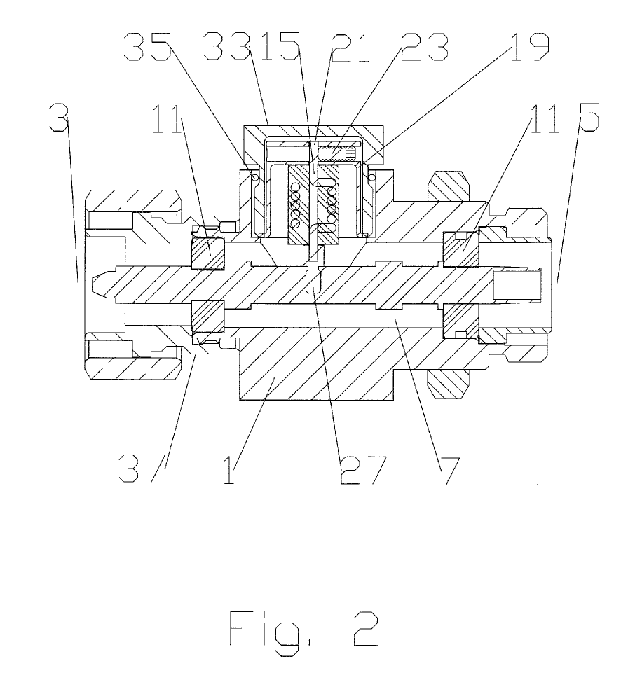

The invention is described with reference to an exemplary first embodiment as shown in FIGS. 1-4.

The surge suppressor body 1 is formed as an in-line assembly dimensioned for a desired co-axial cable or transmission line with a first connection end 3 and a second connection end 5 adapted to couple with a co-axial cable or other equipment at either end via a desired proprietary or standardized connection interface(s). The body 1 has a bore 7 in which an inner conductor 9 is positioned, also extending between the first connection end 3 and the second connection end 5 to similarly couple with a cable inner conductor or other equipment. The inner conductor 9 may be positioned coaxial within the bore 7 and isolated from the body 1 by one or more insulator(s) 11. A surge suppressor insert mount 13 is formed in a side of the body 1, between the first connection end 3 and the second connection end 5. The surge suppressor insert mount 13 is adapted to couple a frequency selective shorting element between the inner conductor 9 and the outer conductor, i.e. the body 1.

The frequency selective shorting element may be formed as a wound wire inductor 15. A first end 17 of the wound wire inductor 15 is connected to a top of a hollow cap 19, for example by insertion into a hole 21 formed in the hollow cap 19 and application of a retaining means such as a screw 23, conductive adhesive, interference fit and or soldering. A second end 25 of the wound wire inductor is dimensioned to mate with the inner conductor 9 when the hollow cap 19 is seated within the surge suppression insert mount 13. For example, a threaded contact 27 coupled to the second end 25 of the wire wound inductor may be adapted to thread into a threaded hole 29 in the inner conductor 9.

The wire used to form the wire wound inductor 15 preferably has a cross sectional area selected to have adequate current carrying capacity for handling the expected magnitude of the current surges the surge suppressor is configured to couple to the outer conductor and or ground.

The present inventors have recognized that forming the wound wire inductor 15 from wire, rather than machining or stamping the inductor has several advantages. A higher level of inductance can be achieved, relative to a stamped or machined inductor of the same size, because a minimum spacing required for stamping or cutting tools is eliminated when an insulating coating is applied to the wire before winding the inductor with the adjacent coils in contact with each other. Thereby, the overall size requirements of the inductor for a given inductance is reduced. Also, wire winding equipment is relatively simple to configure for a desired inductor coil diameter and length, allowing cost effective production of a wide range of different inductors with inductances selected in combination with any straight portion(s) of the wire wound inductor coil 15 for specific frequency bands.

Further, as the width between the inductor windings is minimized, a parasitic capacitance of the inductor is increased. While an ideal inductor has an increasing impedance with respect to increasing frequency, the presence of parasitic capacitance has the inverse effect. Thereby, the interaction of both the inductive and capacitive effects creates a self resonance frequency where the impedance of the inductor is maximized. By tuning the length of any linear portion(s), the number of turns, diameter and coil to coil spacing of the wire wound inductor 15, the inductance and parasitic capacitance characteristics of the wire wound inductor may be adapted so that the self resonance frequency is positioned at the center of the desired frequency band. Thereby, the insertion loss represented by the presence of the surge suppressor along the coaxial cable may be minimized within the desired frequency band. The self resonance frequency characteristic of the wire wound inductor reduces the extent of a linear portion needed to avail the surge suppressor insert of broadband characteristics, for example as disclosed in Aleksa et al., allowing a significant reduction in the overall size requirements for a surge suppressor according to the invention. Where desired, the linear portion(s) may be accommodated by extending the height of the hollow cap 19.

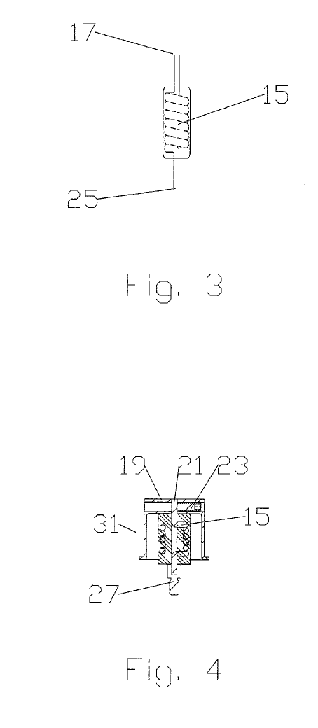

Additional tuning of the wire wound inductor 15 impedance characteristics may be applied by adjusting the dielectric value of the material around which the inductor is wound and or that may be inserted between the adjacent individual coils. For example, a core material with a specific dielectric value may be applied and or the wire wound inductor may be fully encapsulated in a dielectric, for example as shown in FIG. 3. As shown for example in FIG. 4, an encapsulated wire wound inductor 15, hollow cap 19 and threaded contact 27, may be pre-assembled, to form an integral surge suppression insert 31. The surge suppressor insert 31 provides a ready to install assembly that minimizes the chance for damage or loss of loose components prior to installation. One skilled in the art will appreciate that encapsulation of the wire wound inductor 15 and the hollow cap 19 of the surge suppression insert 31 both help to contain damage to the body 1 if the wire wound inductor 15 is subjected to an out of range and or repeated surge(s).

The hollow cap 19 may be held in place by a retaining cover 33 which threads into the body 1, biasing the hollow cap 19 into secure contact with the body 1. The retaining cap 19 may also include an environmental seal 35, such as an o-ring, to prevent moisture migration into the body 1 and thereby into the connected coaxial cables and or equipment. A mounting point, such as a threaded hole, useful for mounting the surge suppressor to a desired location and or attaching a ground lead may also be formed in the body 1. While the surge suppressor insert 31 has been demonstrated for use with a dedicated body 1, it should also be appreciated that the surge suppressor insert 31 may be easily adapted for use with existing surge suppressor bodies originally supplied with other forms of surge suppression elements, such as quarter wave stubs and or helically machined inductor/stub combinations.

To simplify assembly of the surge suppressor and or allow repair of a surge damaged surge suppressor, the body 1 may be formed to receive a retainer element 37 that includes the first connection end 3. The retainer element 37 allows the inner conductor 9 and associated insulator(s) 11 to be initially assembled and or exchanged and then securely retains the components in place. The retainer element 37 may be coupled to the body, for example, via mating threads and or an interference fit. Alternatively, the retainer element 37 may be omitted and the inner conductor 9 mounted within the body by press fitting or injection molding the insulator(s) 11, about the pre-positioned inner conductor 9, within the bore 7.

One skilled in the art will appreciate that the present invention represents a significant improvement in size requirements, ease of use, manufacturing and cost efficiency. The overall materials requirements, machining operations and total number of discrete components are reduced. The readily exchangeable surge suppression insert(s) 31 according to the invention may be cost effectively manufactured for a wide range of different frequency bands. Also, surge suppressors according to the invention for specific frequency bands may be quickly assembled for on-demand delivery with minimal lead time, eliminating the need for large stocks of pre-assembled frequency band specific surge suppressor inventory. Further, should a surge suppressor be damaged, or the desired frequency band of operation change, the surge suppression insert 31 may be easily exchanged by the user without disturbing connections to surrounding equipment.

Table of Parts

| | |
|---|---|
| 1 | body |
| 3 | first connection end |
| 5 | second connection end |
| 7 | bore |
| 9 | inner conductor |
| 11 | insulator |
| 13 | surge suppression insert mount |
| 15 | wire wound inductor |
| 17 | first end |
| 19 | hollow cap |
| 21 | hole |
| 23 | screw |
| 25 | second end |
| 27 | threaded contact |
| 29 | threaded hole |
| 31 | surge suppression insert |
| 33 | retaining cover |
| 35 | environmental seal |
| 37 | retainer element |

Where in the foregoing description reference has been made to ratios, integers, components or modules having known equivalents then such equivalents are herein incorporated as if individually set forth.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described. Accordingly, departures may be made from such details without departure from the spirit or scope of applicant's general inventive concept. Further, it is to be appreciated that improvements and/or modifications may be made thereto without departing from the scope or spirit of the present invention as defined by the following claims.

What is claimed is:

1. A surge suppression insert, comprising:
a hollow cap with an open end having a top,
a wire wound inductor seated in the open end,
the wore wound inductor coupled to the top at a first end and having a threaded contact at a second end.

2. The assembly of claim 1, wherein the wire wound inductor is a cylindrical coil.

3. The assembly of claim 2, wherein the cylindrical coil surrounds a plastic dielectric.

4. The assembly of claim 1, wherein the wire wound inductor is encapsulated in a plastic dielectric.

5. The assembly of claim 1, wherein the wire wound inductor is coupled to the top at the first end by insertion of the first end into a hole in the top.

6. The assembly of claim 1, wherein the wire wound inductor has a linear portion.

7. The assembly of claim 1, wherein the wire wound inductor has an inductance selected for operation in a desired frequency band.

8. An in-line surge suppressor, comprising:
a body having a coaxial connection interface at a first connector end and a second connector end;
a surge suppressor insert mount formed in the body between the first end and the second end;
a surge suppressor insert mounted in the surge suppressor insert mount, comprising:
a hollow cap with an open end and a top,
a wire wound inductor seated within the open end,
the wire wound inductor coupled to the top at a first end and having a threaded contact at a second end; and
a center conductor extending between the first connector end and the second connector end, having a threaded hole proximate the surge suppressor insert mount adapted to mate with the threaded contact.

9. The assembly of claim 8, wherein the wire wound inductor is a cylindrical coil.

10. The assembly of claim 9, wherein the cylindrical coil surrounds a plastic dielectric.

11. The assembly of claim 8, wherein the wire wound inductor is encapsulated in a plastic dielectric.

12. The assembly of claim 8, wherein the wire wound inductor is coupled to the top at the first end by insertion of the first end into a hole in the top.

13. The assembly of claim 8, wherein the wire wound inductor has a linear portion.

14. The assembly of claim 8, further including a retaining cover, adapted to retain the surge suppressor insert in the surge suppressor mount.

15. The assembly of claim 14, further including an environmental seal between the retaining cover and the body.

16. The assembly of claim 8, wherein the center conductor is retained coaxial with a longitudinal axis of the body by an insulator.

17. The assembly of claim 8, wherein the surge suppressor insert is adapted for a desired frequency band.

18. The assembly of claim 8, wherein the body has a mounting point for a ground connection.

19. A surge suppressor, comprising:
a body adapted to receive a surge suppressor insert having a wire wound inductor coupled between a hollow cap of the surge suppressor insert and an inner conductor positioned coaxial within a bore of the body, by an insulator.

20. The assembly of claim 19, further including a retainer coupled to the body, the retainer retaining the inner conductor within the bore.
